(19) United States
(12) Patent Application Publication
(10) Pub. No.: US 2026/0075013 A1
(43) Pub. Date: Mar. 12, 2026

(54) INFORMATION PROCESSING METHOD AND APPARATUS, ELECTRONIC DEVICE, AND COMPUTER READABLE MEDIUM

(71) Applicant: Beijing Zitiao Network Technology Co., Ltd., Beijing (CN)

(72) Inventors: Fangjia CHEN, Beijing (CN); Zhengwen WANG, Beijing (CN); Zhong WANG, Beijing (CN); Fengjuan SHI, Beijing (CN); Chao ZHANG, Beijing (CN); Jiachen ZHAO, Beijing (CN); Liuyuan YU, Beijing (CN); Shengqi SU, Beijing (CN)

(21) Appl. No.: 19/108,423

(22) PCT Filed: Feb. 18, 2024
(86) PCT No.: PCT/CN2024/077411

§ 371 Date: Mar. 3, 2025

(30) Foreign Application Priority Data
Feb. 28, 2023 (CN) 202310184289.6

(51) Int. Cl. H04L 51/04; G06F 3/0488

(52) U.S. Cl. CPC H04L 51/04; G06F 3/0488

(57) ABSTRACT

An information processing method and apparatus, an electronic device, and a computer-readable medium are provided. The method includes: displaying one or more information-bearing containers in a chat interface of a client of a communication system after receiving a first preset operation, and displaying preset information in the information-bearing containers, so that the preset information is not displayed as a chat message in a chat corresponding to the chat interface, but displayed in a display manner that is completely different from that of chat information. In this way, all chat messages involved in the chat interface do not interfere with a process of a chat participant in the chat interface paying attention to the preset information, so as to better improve the display effect of some information in the chat interface, which is conducive to improving the user experience.

The present application claims priority to Chinese Patent Application No. 202310184289.6, filed with the China National Intellectual Property Administration on Feb. 28, 2023, and entitled “INFORMATION PROCESSING METHOD AND APPARATUS, ELECTRONIC DEVICE, AND COMPUTER-READABLE MEDIUM”, which is incorporated herein by reference in its entirety.

### FIELD

The present disclosure relates to the field of Internet technologies, and in particular, to an information processing method and apparatus, an electronic device, and a computer-readable medium.

### BACKGROUND

In some application scenarios, users can communicate by using a certain type of instant messaging software, so that the users can promptly learn about some messages. For example, a user may learn about some information from a chat group. The chat group is composed of a plurality of chat participants, so that the chat participants can communicate in a chat interface corresponding to the chat group.

In collaborative communication scenarios, group chats are a commonly used communication tool for collaborative teams. In addition, the collaborative teams also pay attention to other business data, so that the collaborative team usually needs to send relevant business data to the group chat in the form of group messages to achieve information sharing. However, this operation method is cumbersome, resulting in a poor user experience.

### SUMMARY

In order to solve the technical problems described above, the present disclosure provides an information processing method and apparatus, an electronic device, and a computer-readable medium, which can better improve the user experience.

To achieve the above object, the present disclosure provides the following technical solutions.

The present disclosure provides an information processing method. The method includes: displaying one or more information-bearing containers in a chat interface of a client of a communication system in response to a first preset operation; and

displaying preset information in the one or more information-bearing containers,
where the preset information is not a chat message in a chat corresponding to the chat interface.

In a possible implementation, displaying the one or more information-bearing containers in the chat interface of the client of the communication system includes:

displaying a container display area in the chat interface of the client of the communication system, and displaying the one or more information-bearing containers in the container display area.

In a possible implementation, displaying the preset information in the one or more information-bearing containers includes:

obtaining, for one information-bearing container, data from a business party associated with the information-bearing container, and displaying the obtained data in the information-bearing container,
where in a case where the chat interface includes a plurality of information-bearing containers, the plurality of information-bearing containers correspond to the same business party or different business parties.

In a possible implementation, displaying the obtained data in the information-bearing container includes:

rendering and displaying the obtained data in the information-bearing container based on a display template provided by the business party.

In a possible implementation, there is a preset association between the information-bearing container and a preset link address of the business party, and

obtaining the data from the business party associated with the information-bearing container includes: obtaining the data of the business party from a page corresponding to the preset link address associated with the information-bearing container;
or
there is a preset association between the information-bearing container and a preset information access interface of the business party, and
obtaining data from the business party associated with the information-bearing container includes: obtaining the data of the business party from the preset information access interface associated with the information-bearing container.

In a possible implementation, the method further includes:

updating, in real time and based on changes in the preset information, information displayed in the one or more information-bearing containers.

In a possible implementation, the first preset operation includes any one of:

an operation to open the chat interface; or
a second preset operation triggered in the chat interface.

In a possible implementation, after displaying the container display area in the chat interface of the client of the communication system, the method further includes:

adjusting the container display area from a first display state to a second display state in response to a preset adjustment operation, where a display area of the container display area in the first display state is different from that of the container display area in the second display state.

In a possible implementation, in a case where the chat interface includes a plurality of information-bearing containers, displaying the one or more information-bearing containers in the container display area includes:

displaying, within the container display area, a container among the plurality of information-bearing containers that meets a preset condition; and
after displaying, within the container display area, the container among the plurality of information-bearing containers that meets the preset condition, the method further includes:
in response to a first swipe operation triggered for the container display area, increasing a display area of the container display area, and displaying, within a newly added space of the container display area, at least one information-bearing container among the plurality of information-bearing containers other than the container that meets the preset condition.

In a possible implementation, after increasing the display area of the container display area, the method further includes:

reducing the display area of the container display area in response to a second swipe operation triggered for the container display area, where a movement direction of the second swipe operation is opposite to that of the first swipe operation;
or
reducing the display area of the container display area in response to a swipe operation triggered for a chat display area in the chat interface, where the chat display area is used to display chat messages in the chat corresponding to the chat interface;
or
reducing the display area of the container display area in response to a trigger operation for an information input control in the chat interface.

In a possible implementation, after reducing the display area of the container display area, the method further includes:

upon determining that the display area of the container display area is reduced to a first area threshold, canceling display of some or all of the information-bearing containers displayed within the newly added space; and
upon determining that the display area of the container display area is reduced to a second area threshold, canceling display of the container that meets the preset condition in the container display area, or canceling display of the container display area on the chat interface, where the second area threshold is less than the first

In a possible implementation, the container display area is located within a sidebar area of the chat interface;

the chat interface includes a container entry identifier; and
after the displaying a container display area in the chat interface of the client of the communication system, the method further includes:
canceling display of the container display area on the chat interface in response to a trigger operation for the container entry identifier.

In a possible implementation, the method further includes:

copying a link address of the preset information in response to a trigger operation for a first control in the information-bearing container, where a page corresponding to the link address is used to display the preset information;
or
displaying a comment input control in response to a trigger operation for a second control in the information-bearing container.

In a possible implementation, the information-bearing container is a widget.

The present disclosure provides an information processing apparatus. The apparatus includes:

a first display unit configured to display one or more information-bearing containers in a chat interface of a client of a communication system in response to a first preset operation; and
a second display unit configured to display preset information in the one or more information-bearing containers, where the preset information is not a chat message in a chat corresponding to the chat interface.

The present disclosure provides an electronic device. The electronic device includes: a processor and a memory, where

the memory is configured to store instructions or a computer program; and
the processor is configured to execute the instructions or computer program in the memory to cause the electronic device to perform the information processing method according to the present disclosure.

The present disclosure provides a computer-readable medium storing instructions or a computer program, when the instructions or the computer program runs on a device, the device is caused to perform the information processing method according to the present disclosure.

The present disclosure provides a computer program product, which includes a computer program carried on a non-transitory computer-readable medium, where the computer program includes program code for performing the information processing method according to the present disclosure.

In contrast to the prior art, the present disclosure has at least the following advantages.

In the technical solutions according to the present disclosure, for a communication system (e.g., a certain type of instant messaging software), upon receiving a first preset operation (e.g., an operation to open a chat interface of a certain group, etc.) triggered for a client of the communication system, one or more information-bearing containers are displayed in the chat interface of the client of the communication system, and preset information (e.g., information that requires attention from some or all members of a certain chat group) is displayed in the information-bearing containers, so that the preset information is not displayed as a chat message in a chat corresponding to the chat interface, but displayed in a display manner that is completely different from that of chat information. In this way, all chat messages involved in the chat interface do not interfere with the user's process of paying attention to the preset information, so as to better improve the display effect of some information in the chat interface (especially the display effect of some information that requires attention), which is conducive to improving the user experience (especially the viewing experience for some information that requires attention).

### BRIEF DESCRIPTION OF THE DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show merely some embodiments recited in the present disclosure, and those of ordinary skill in the art may still derive other accompanying drawings from these accompanying drawings without creative efforts.

FIG. 1 is a flowchart of an information processing method according to an embodiment of the present disclosure;

FIG. 2 is a schematic diagram of an interaction process for a communication system according to an embodiment of the present disclosure;

FIG. 3 is a schematic diagram of another interaction process for a communication system according to an embodiment of the present disclosure;

FIG. 4 is a schematic diagram of still another interaction process for a communication system according to an embodiment of the present disclosure;

FIG. 5 is a schematic diagram of a chat interface according to an embodiment of the present disclosure;

FIG. 6 is a schematic diagram of another chat interface according to an embodiment of the present disclosure;

FIG. 7 is a schematic diagram of a structure of an information processing apparatus according to an embodiment of the present disclosure; and

FIG. 8 is a schematic diagram of a structure of an electronic device according to an embodiment of the present disclosure.

### DETAILED DESCRIPTION OF EMBODIMENTS

In practice, for some communication systems (e.g., a certain type of instant messaging software), the way they display information provided for a chat group is relatively limited. For example, for a chat group, different group members in the chat group usually communicate with each other by means of chat messages. This can easily result in some information that requires attention from all the group members being overwhelmed by a large number of chat messages, making it difficult for some group members to directly notice the information that requires attention, and causing some group members to have to perform complex operations to find the information that requires attention from among a large amount of chat information, which has a significant impact on the user experience.

Based on the above content, in order to better improve the user experience, the present disclosure provides an information processing method. The method may be specifically as follows. For a communication system (e.g., a certain type of instant messaging software), upon receiving a first preset operation (e.g., an operation to open a chat interface of a certain group, etc.) triggered for a client of the communication system, one or more information-bearing containers are displayed in the chat interface of the client of the communication system, and preset information (e.g., information that requires attention from some or all members of a certain chat group) is displayed in the information-bearing containers, so that the preset information is not displayed as a chat message in a chat corresponding to the chat interface, but displayed in a display manner that is completely different from that of chat information. In this way, all chat messages involved in the chat interface do not interfere with the user's process of paying attention to the preset information, and further, the user can quickly view the preset information by means of these information-bearing containers, so as to better improve the display effect of some information in the chat interface (especially the display effect of some information that requires attention), which is conducive to improving the user experience (especially the viewing experience for some information that requires attention).

In addition, embodiments of the present disclosure do not limit the execution body of the information processing method provided in the embodiments of the present disclosure. For example, the information processing method provided in the embodiments of the present disclosure may be applied to a terminal device or a server. For another example, the information processing method provided in the embodiments of the present disclosure may also be implemented by means of a data interaction process between a terminal device and a server. The terminal device may be a smartphone, a computer, a personal digital assistant (PDA) or a tablet. The server may be a stand-alone server, a cluster server, or a cloud server.

In order for persons skilled in the art to better understand the solutions of the present disclosure, the technical solutions in the embodiments of the present disclosure will be described below clearly and completely with reference to the accompanying drawings in the embodiments of the present disclosure. Apparently, the embodiments described are merely some rather than all of the embodiments of the present disclosure. All other embodiments obtained by those of ordinary skill in the art based on the embodiments of the present disclosure without any creative efforts shall fall within the scope of protection of the present disclosure.

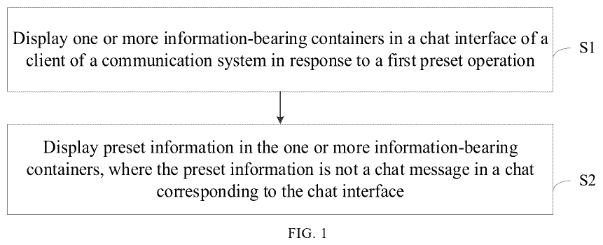

For a better understanding of the technical solutions provided in the present disclosure, the information processing method provided in the present disclosure is first described below with reference to some accompanying drawings. As shown in FIG. 1, an information processing method according to an embodiment of the present disclosure includes the following steps S1 to S2. FIG. 1 is a flowchart of an information processing method according to an embodiment of the present disclosure.

S1: Display one or more information-bearing containers in a chat interface of a client of a communication system in response to a first preset operation.

The communication system is used to provide a user with a function of communicating with other users. Moreover, the communication system is not limited in the present disclosure. For example, the communication system may be any existing or future communication system (e.g., a certain type of instant messaging system).

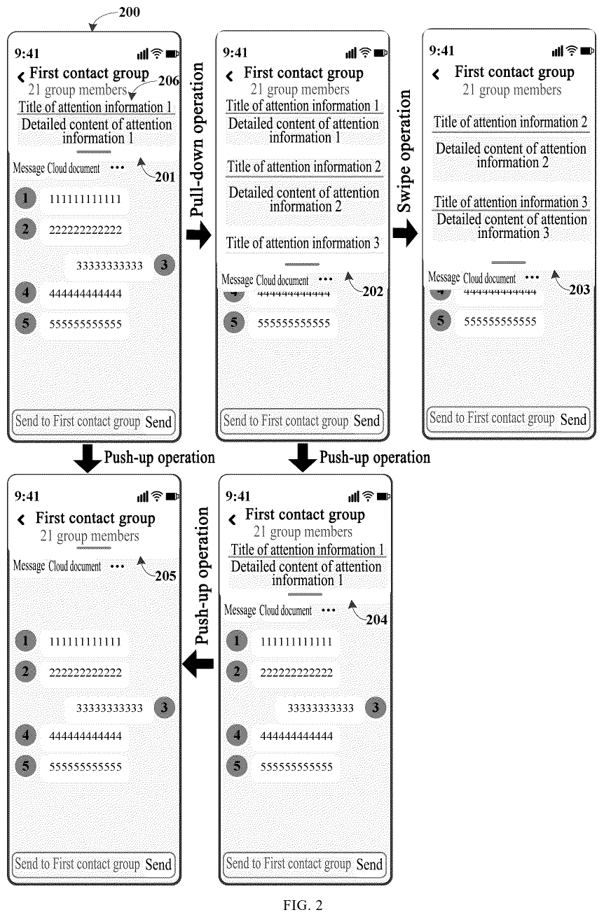

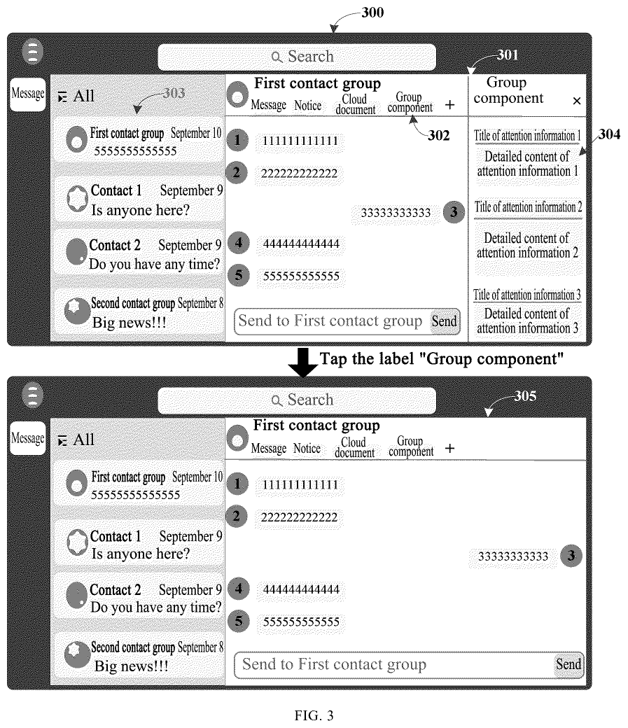

The chat interface is used to display an information exchange process between at least two users. Moreover, the chat interface is not limited in the present disclosure. For example, the chat interface may refer to a chat interface corresponding to a certain chat group (e.g., a chat interface 200 shown in FIG. 2, or a chat interface 301 shown in a page 300 in FIG. 3, etc.), so that the chat interface is used to display an information exchange process among group members in the chat group. For another example, the chat interface may also be any other form of chat interface, which is not specifically limited in the present disclosure.

The information-bearing container refers to a container that has an information-bearing function, so that the information-bearing container is used to bear and display some data information that is different from a chat message (especially some information that requires constant attention from the users in the chat). For example, the information-bearing container may refer to a container 206 shown in FIG. 2 and a container 304 shown in FIG. 3.

In addition, the implementation of the information-bearing container is not limited in the present disclosure. For example, the information-bearing container may be implemented by using any existing or future container that has the information-bearing function. For another example, the information-bearing container may also be a container that is designed for an actual application scenario and suitable for the application scenario, and has the information-bearing function. For yet another example, in application scenarios of some embodiments, the information-bearing container may be implemented by using a widget, so that important information in the chat group can be dynamically displayed on the chat interface by means of the widget, so as to facilitate the group members pay attention to the information in time, which is conducive to focusing the attention of the group members on the information borne and displayed by the information-bearing container. That is, in a possible implementation, the information-bearing container may be a widget.

In addition, the content borne and displayed in the information-bearing container is not limited in the present disclosure. For example, the content may be implemented by using preset information in the embodiments below. For relevant content of the preset information, refer to relevant content of S2 below, which will not be repeated here for the sake of brevity.

The first preset operation is used to trigger a display process of the information-bearing container on the chat interface. Moreover, the implementation of the first preset operation is not limited in the present disclosure, and for ease of understanding, description is provided below in conjunction with two cases.

Case 1: in some application scenarios (e.g., in scenarios where the information-bearing container is displayed by default when the chat interface is displayed), in order to better improve the information display effect, the information-bearing container may be displayed while the chat interface is unfolded, so that the user can see the information borne and displayed by the information-bearing container without performing any operation after the chat interface is unfolded.

Based on the relevant content of the above Case 1, it can be seen that in some application scenarios, the information-bearing container may be displayed while the chat interface is opened. Based on this, the present disclosure provides a possible implementation of the first preset operation, in which the first preset operation may specifically refer to an operation to open the chat interface. It can be seen that, in some application scenarios, the first preset operation may refer to any existing or future operation capable of opening the chat interface (e.g., a tap operation for an area 303 in FIG. 3, etc.).

Case 2: in some application scenarios, the information-bearing container is not displayed while the chat interface is opened. Instead, the display process of the information-bearing container is triggered by the user by means of some operation when the user needs the information-bearing container.

Based on the relevant content of the above Case 2, the present disclosure provides another possible implementation of the first preset operation, in which the first preset operation may specifically refer to a second preset operation triggered in the chat interface when the chat interface is in a display state. The second preset operation refers to an operation triggered for the chat interface for triggering the display process of the information-bearing container on the chat interface. Moreover, the second preset operation is not limited in the present disclosure. For example, the second preset operation may be implemented by using a certain type of preset gesture.

For another example, in some application scenarios (e.g., when the information processing method provided in the present disclosure is applied to a large-screen terminal like a personal computer), if the chat interface includes a container entry identifier, the second preset operation may refer to a trigger operation (e.g., a tap operation, etc.) for the container entry identifier. The container entry identifier is used to identify a viewing entry of the information-bearing container. Moreover, the implementation of the container entry identifier is not limited in the present disclosure. For example, in an embodiment, the container entry identifier may be implemented by using a group label “Group component”as shown in the area 302 in FIG. 3.

For yet another example, in some application scenarios (e.g., when the information processing method provided in the present disclosure is applied to a small-screen terminal like a mobile phone), if a title area in the chat interface (e.g., an area 205 shown in FIG. 2) is used to display the information-bearing container, the second preset operation may refer to a pull-down operation triggered for the title area (i.e., an operation to press and hold a certain position in the title area and swipe in a direction away from a top

In practice, in order to better prevent some information from being interfered by chat messages, the present disclosure further provides a possible implementation of the chat interface, in which the chat interface may include a chat display area and a container display area (e.g., an area 201 shown in FIG. 2, or a sidebar area shown in the page 300 in FIG. 3, or an area 201 shown in FIG. 4, etc.), and there is no overlapping area between the chat display area and the container display area. The chat display area is used to display chat messages in a chat corresponding to the chat interface. The container display area is used to display the one or more information-bearing containers.

In addition, a positional relationship between the chat display area and the container display area is not limited in the present disclosure. For example, a position of the chat display area in the chat interface is adjacent to a position of the container display area in the chat interface in a horizontal or vertical direction.

In addition, the position of the container display area in the chat interface is not limited in the present disclosure. For example, in order to better improve the display effect of some information that requires attention, in some application scenarios (e.g., when the information processing method provided in the present disclosure is applied to a small-screen terminal like a mobile phone), the container display area may be at the top area of the chat interface. For another example, in some application scenarios (e.g., when the information processing method provided in the present disclosure is applied to a large-screen terminal like a personal computer), the container display area may be within the sidebar area in the chat interface.

Based on the content of the above three paragraphs, it can be seen that in a possible implementation, S1 above may specifically be: in response to the first preset operation, displaying the container display area (e.g., the area 201 shown in FIG. 2, or the sidebar area shown in the page 300 in FIG. 3, etc.) in the chat interface of the client of the communication system, and displaying the one or more information-bearing containers in the container display area. Because the container display area is completely independent of a display area of the chat information in the chat interface (i.e., the “chat display area”), the displayed information within the container display area is not interfered by the chat information in the chat interface, so that the information-bearing containers displayed within the container display area will not be interfered by the chat information in the chat interface, and further, information borne by the information-bearing containers will not be interfered by the chat information in the chat interface, thereby effectively avoiding adverse effects caused by interference of the chat information, which is conducive to improving the user experience.

Based on the relevant content of S1 above, it can be seen that for a communication system (e.g., a certain type of instant messaging software), upon receiving a first preset operation (e.g., an operation to open a chat interface of a certain group, etc.) triggered for a client of the communication system, one or more information-bearing containers are displayed in the chat interface of the client of the communication system, so that the user of the client can quickly learn some information that requires attention by means of these information-bearing containers, so as to better improve the display effect of the information, which is conducive to improving the user experience.

S2: Display preset information in the one or more information-bearing containers, where the preset information is not a chat message in a chat corresponding to the chat interface.

The preset information refers to content borne and displayed by the information-bearing container. Moreover, the preset information is not a chat message in the chat corresponding to the chat interface. It can be seen that the preset information may refer to a type of data information that is different from the chat information and displayed by means of the information-bearing container.

In addition, the implementation of the preset information is not limited in the present disclosure. For example, the preset information may be data information provided by a certain business party (e.g., the progress of a project/task, the development of a matter, etc.). The business party refers to a service business (e.g., an application, a document, a web page, etc.) capable of providing data to the information-bearing container. Moreover, the business party is not limited in the present disclosure. For example, in some embodiments, the business party may be a service business integrated in the communication system itself. For another example, in other embodiments, the business party may also be a service business independent of the communication system.

For another example, the preset information may also be part or all of data in a data document.

For yet another example, the information-bearing container may also be other information that requires attention (especially information that requires constant attention to its changes), which is not specifically limited in the present disclosure.

In practice, in order to better satisfy the information display effect, the present disclosure further provides a possible implementation of the above S2, which may specifically be: obtaining, for any one information-bearing container, data from a business party associated with the information-bearing container, and displaying the obtained data in the information-bearing container, so that the data involved in the business party associated with the information-bearing container can be borne and displayed by the information-bearing container.

In addition, the implementation of the business party corresponding to each information-bearing container in the chat interface is not limited in the present disclosure. For example, when the chat interface includes a plurality of information-bearing containers, the plurality of information-bearing containers may correspond to the same business party or different business parties, which is not specifically limited in the present disclosure.

It can be seen that for the chat interface, if only one information-bearing container is deployed on the chat interface, the information-bearing container may be associated with a type of business party, so that the information-bearing container can be used to bear and display the data obtained from the business party. However, if a plurality of information-bearing containers are deployed on the chat interface, the business parties associated with these information-bearing containers may be configured according to the actual application scenario, so that these information-bearing containers can be used to bear and display the data obtained from one or more business parties, which is conducive to improving the richness of data display, thereby improving the user experience.

In addition, the implementation of obtaining the data from the business party is not limited in the present disclosure, and for ease of understanding, description is made below in conjunction with two examples.

Example 1: in some application scenarios (e.g., when the business party may display data by means of a web page), the data from the business party may be obtained by means of a preset link address of the business party. The preset link address is used to uniquely identify a web page corresponding to the business party, and the web page corresponding to the business party is used to display some information resources provided by the business party. It can be seen that in a possible implementation, the preset link address may refer to an address for obtaining the information resources of the business party. In addition, the preset link address is not limited in the present disclosure. For example, the preset link address may be implemented by using a uniform resource locator (URL).

Based on the above content, it can be seen that in a possible implementation, for any information-bearing container, when there is a preset association between the information-bearing container and a preset link address of a business party, the above S2 may specifically include: obtaining the data of the business party from a page corresponding to the preset link address associated with the information-bearing container, and displaying the obtained data in the information-bearing container. The page corresponding to the preset link address refers to a web page having the preset link address. Moreover, the page corresponding to the preset link address may be used to display the information resources of the business party.

Based on the relevant content of Example 1 above, it can be seen that in a possible implementation, for any one information-bearing container deployed on the chat interface, a preset link address of one business party may be associated with the information-bearing container in advance, so that when the information-bearing container is displayed on the chat interface, data of the business party may be obtained from a page corresponding to the preset link address associated with the information-bearing container, and the obtained data may be displayed in the information-bearing container, so that the information-bearing container can be used to bear and display the data of the business party, enabling the user to view information resources of the business party without leaving the chat interface, which is conducive to improving the information viewing experience of the user.

Example 2: in some application scenarios (e.g., when the business party may perform data communication with other objects by means of a preset access interface), the data from the business party may be obtained by means of a preset information access interface of the business party. The preset information access interface refers to an interface that is set in advance for the business party and allows data access from other objects (e.g., an application, etc.). Moreover, the preset information access interface is not limited in the present disclosure.

Based on the above content, it can be seen that in a possible implementation, for any one information-bearing container, when there is a preset association between the information-bearing container and a preset information access interface of a business party, the above S2 may specifically include: obtaining the data of the business party from the preset information access interface associated with the information-bearing container, and displaying the obtained data in the information-bearing container.

Based on the relevant content of the above Example 2, it can be seen that in a possible implementation, for any one information-bearing container deployed on the chat interface, a preset information access interface of a business party may be associated with the information-bearing container in advance, so that when the information-bearing container is displayed on the chat interface, data of the business party may be obtained from the preset information access interface associated with the information-bearing container, and the obtained data may be displayed in the information-bearing container, so that the information-bearing container may be used to bear and display the data of the business party. In this way, the user can view information resources of the business party without leaving the chat interface, which is conducive to improving the information viewing experience of the user.

In practice, in order to better improve the information display effect, the present disclosure further provides a possible implementation of the above S2, in which S2 may specifically be: obtaining, for one information-bearing container, data from a business party associated with the information-bearing container, and rendering and displaying the obtained data in the information-bearing container based on a display template provided by the business party. The display template refers to a template provided by the business party for use in displaying the “obtained data”. Moreover, the obtaining manner of the display template is not limited in the present disclosure. For example, the display template may be obtained along with the obtaining process of the “obtained data”. For another example, the display template may also be obtained from a storage space specified by the business party. For yet another example, the display template may also be obtained in other manners, which is not specifically limited in the present disclosure.

It should be noted that an association between the execution time of the step “displaying preset information in the one or more information-bearing containers” in the above S2 and the execution time of the step “displaying one or more information-bearing containers in a chat interface of a client of a communication system” in the above S1 is not limited in the present disclosure. For example, the two execution times may be the same. For another example, the former may be later than the latter.

Based on the relevant content of the above S1 to S2, it can be seen that for the information processing method provided in this embodiment of the present disclosure, upon receiving a first preset operation (e.g., an operation to open a chat interface of a certain group, etc.) triggered for a client of the communication system, one or more information-bearing containers are displayed in the chat interface of the client of the communication system, and preset information (e.g., information that requires attention from some or all members of a certain chat group) is displayed in these information-bearing containers, so that the preset information is not displayed as a chat message in a chat corresponding to the chat interface, but displayed in a display manner that is completely different from that of chat information. In this way, all chat messages involved in the chat interface do not interfere with the user's process of paying attention to the preset information, so as to better improve the display effect of some information in the chat interface (especially the display effect of some information that requires attention), which is conducive to improving the user experience (especially the viewing experience for some information that requires attention).

In practice, in some application scenarios, for the preset information displayed in the chat interface by means of the information-bearing container, the preset information may not be static, but may be dynamically changed. Therefore, in order to better improve the information display effect, the present disclosure further provides a possible implementation of the information processing method, in which the information processing method may include not only the above S1 to S2, but also step 11 below. The execution time of step 11 is later than that of S2.

Step 11: Update, in real time and based on changes in the above preset information, information displayed in the one or more information-bearing containers, so that the information displayed in the one or more information-bearing containers is kept consistent with the preset information.

In the present disclosure, for the chat interface, when there are one or more containers displayed on the chat interface and there is preset information displayed in the one or more information-bearing containers, when the preset information is updated, information displayed in the one or more information-bearing containers may be updated in real time based on changes in the preset information, so as to ensure consistency between the information borne and displayed by the information-bearing containers and the preset information, thereby achieving the purpose of real-time display of the preset information through these information-bearing containers, enabling the user to stay informed about dynamic changes in the preset information in real time without leaving the chat interface, which is conducive to improving the information viewing experience of the user.

Based on the relevant content of the above step 11, it can be seen that for a communication system (e.g., a certain type of instant messaging software), when there is one or more information-bearing containers displayed in the chat interface of a client of the communication system and there is preset information displayed in the one or more information-bearing containers, the content borne and displayed by these information-bearing containers may change as the preset information changes, thereby achieving the purpose of dynamically displaying some information that requires attention by means of these information-bearing containers, so as to enable chat participants involved in the chat interface to better focus on the content borne and displayed by these information-bearing containers, which is conducive to improving the user experience.

In practice, in some application scenarios (e.g., when the information processing method provided in the present disclosure is applied to a small-screen terminal like a mobile phone), if the container display area is adjacent to the chat display area in the chat interface, a boundary line between the container display area and the chat display area may be dynamically adjusted (e.g., a dynamic change process shown in FIG. 2) to meet information display requirements in different situations, which is conducive to improving the user experience.

Based on this, the present disclosure further provides a possible implementation of the information processing method, in which the information processing method may include at least step 21 below. The execution time of step 21 is later than that of the above step “displaying the container display area in the chat interface of the client of the communication system”.

Step 21: Adjust the container display area from a first display state to a second display state in response to a preset adjustment operation, where a display area of the container display area in the first display state is different from that of the container display area in the second display state.

The preset adjustment operation is used to trigger the adjustment process for the display area of the container display area.

In addition, the preset adjustment operation is not limited in the present disclosure. For example, when the container display area is the area 201 shown in FIG. 2, the preset adjustment operation may refer to a pull-down operation triggered for the container display area (i.e., an operation to press and hold a certain position in the container display area and swipe in a direction away from the top boundary line of the chat interface), so as to trigger a process of increasing the display area of the container display area (i.e., an unfolding process for the container display area) by means of the pull-down operation.

For another example, when the container display area is the area 201 shown in FIG. 2, the preset adjustment operation may refer to a push-up operation triggered for the container display area (i.e., an operation to press and hold a certain position in the container display area and swipe in a direction toward the top boundary line of the chat interface), so as to trigger a reduction process for the display area of the container display area (i.e., a folding process for the container display area) by means of the push-up operation.

For yet another example, when the chat interface includes the chat display area and the container display area (e.g., the container display area is the area 201 shown in FIG. 2), the preset adjustment operation may refer to a swipe operation triggered for the chat display area (e.g., an operation to swipe in any direction along the vertical direction), so as to trigger a reduction process for the display area of the container display area (i.e., a folding process for the container display area) by means of the push-up operation.

For another example, when the chat interface includes not only the container display area (e.g., the container display area is the area 201 shown in FIG. 2), but also an information input control, the preset adjustment operation may be a trigger operation for the information input control. The information input control refers to a control to be used during editing of chat information. For example, the information input control may include at least a text input box, an emoticon input control, etc.

The first display state refers to a display state of the container display area before the display area adjustment is performed for the container display area. For example, the first display state may be a display state of the area 201 in FIG. 2.

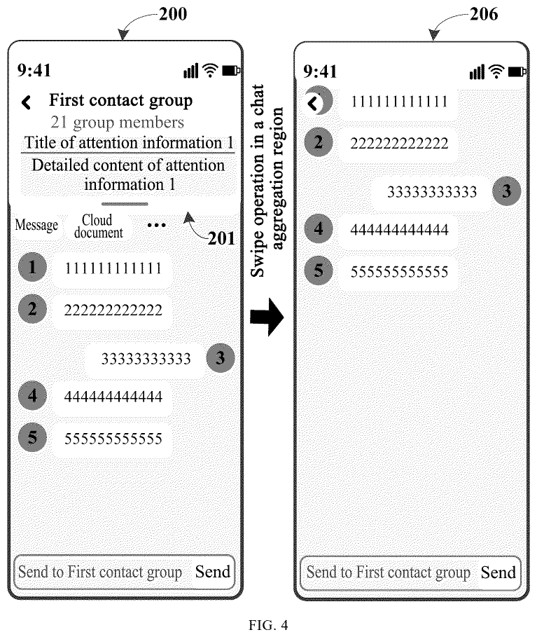

The second display state refers to a display state of the container display area after the display area adjustment is performed for the container display area. For example, when the first display state is the display state of the area 201 in FIG. 2, if the preset adjustment operation is a pull-down operation, the second display state may be a display state of the area 202 in FIG. 2 or a display state of the area 207 in FIG. 5, so that the display area of the container display area in the second display state is larger than that of the container display area in the first display state; and if the preset adjustment operation is a push-up operation (or a swipe operation to move along the vertical direction that is triggered for the chat display area, or a trigger operation for the information input control, etc.), the second display state may be a display state of the area 205 in FIG. 2 or a hidden state shown by the chat interface 206 in FIG. 4, so that the display area of the container display area in the second display state is smaller than that of the container display area in the first display state.

Based on the relevant content of the above step 21, it can be seen that for a communication system (e.g., a certain type of instant messaging software), when a container display area is displayed in a chat interface of a client of the communication system and one or more information-bearing containers are displayed within the container display area, the display area of the container display area may be adjusted based on user operations, so that the display area of the container display area can be adapted to the information display requirements for a current situation to a maximum extent, which is conducive to improving the user experience.

For a better understanding of the above adjustment process, description is made below in conjunction with examples.

As an example, in a possible implementation, the above information processing method may specifically include at least steps 31 to 34 below.

Step 31: Display a container display area in a chat interface of a client of a communication system in response to a first preset operation. The chat interface includes a plurality of information-bearing containers, and the plurality of information-bearing containers are used to display preset information.

Step 32: Display, within the container display area, a container among the plurality of information-bearing containers that meets a preset condition.

The preset condition refers to a condition required to display the container display area in the chat interface.

In addition, the preset condition is not limited in the present disclosure, and the preset condition may be set in advance according to an application scenario. For example, when the chat interface includes a plurality of information-bearing containers, the preset condition may specifically be: an information-bearing container that is arranged at the most forward position of the plurality of information-bearing containers (e.g., the container 206 shown in FIG. 2). It can be seen that in a possible implementation, when the container display area is displayed in the chat interface, only the information-bearing container at the first position of the plurality of information-bearing containers may be displayed within the container display area.

For another example, in order to better improve the information display effect, the present disclosure further provides a possible implementation of the preset condition, in which when the chat interface includes a plurality of information-bearing containers, the preset condition may specifically be: an information-bearing container with the highest importance representation data of the plurality of information-bearing containers. The importance representation data is used to represent importance of an information-bearing container. Moreover, the method for determining the importance representation data is not limited in the implementation of the present disclosure. For example, the importance representation data may be set manually by some users, or may be determined automatically according to a certain type of preset rule, which is not specifically limited in the present disclosure.

Based on the above content, it can be seen that in a possible implementation, when the container display area is displayed in the chat interface, only the information-bearing container with the highest importance representation data of the plurality of information-bearing containers may be displayed within the container display area, so as to ensure that the chat participants involved in the chat interface can view the information that requires most attention in time, which can better improve the information viewing experience of the user.

Based on the relevant content of the above steps 31 to 32, it can be seen that for a communication system (e.g., a certain type of instant messaging software), after a client of the communication system receives a first preset operation (e.g., an operation to open a chat interface of a certain group, etc.), a container display area (e.g., the area 201 shown in FIG. 2) is displayed in the chat interface of the client of the communication system, and a container (e.g., the container 206 shown in FIG. 2) of the plurality of information-bearing containers that meets the preset condition is displayed within the container display area, so that the user can view, from the container, some information that requires his or her attention.

Step 33: In response to a first swipe operation triggered for the container display area, increase a display area of the container display area and display, within a newly added space of the container display area, at least one information-bearing container among the plurality of information-bearing containers other than the container that meets the preset condition.

The first swipe operation is used to trigger a process of increasing the display area of the container display area. Moreover, the first swipe operation is not limited in the present disclosure. For example, the first swipe operation may be a pull-down operation shown in FIG. 2 (i.e., an operation to press and hold a certain position in the container display area and swipe in a direction away from the top boundary line of the chat interface).

The “newly added space of the container display area” refers to an area added for the container display area (e.g., an area difference between the area 202 and the area 201 in FIG. 2) when the step “increasing the display area of the container display area”is performed.

In addition, the method for determining the information-bearing container displayed in the “newly added space of the container display area” is not limited in the present disclosure. For example, the information-bearing container may be determined based on an arrangement order of all the plurality of information-bearing containers.

In practice, in order to better improve the information display effect, the present disclosure further provides a possible implementation of the above step 33, in which when the chat interface includes a container display area and a chat display area, step 33 may specifically be: increasing the display area of the container display area in response to the first swipe operation triggered for the container display area, displaying, in the newly added space of the container display area, the at least one of the plurality of information-bearing containers other than the container that meets the preset condition, and reducing the display area of the chat display area, so that a reduction amount in the display area of the chat display area is equal to an increase amount in the display area of the container display area.

Based on the relevant content of the above steps 31 to 33, it can be seen that for a communication system (e.g., a certain type of instant messaging software), upon receiving a first preset operation (e.g., an operation to open a chat interface of a group, etc.) triggered for a client of the communication system, a container display area (e.g., the area 201 shown in FIG. 2) is first displayed in the chat interface of the client of the communication system, and a container (e.g., the container 206 shown in FIG. 2) among the plurality of information-bearing containers that meets the preset condition is displayed within the container display area, so as to increase the display area of the container display area and reduce the display area of the chat display area in the chat interface upon receiving a first swipe operation (e.g., the “pull-down operation” shown in FIG. 2) triggered for the container display area, thereby achieving the purpose of dynamically adjusting the boundary line between the container display area and the chat display area, so as to better improve the information display effect, which is conducive to improving the user experience.

In practice, in some application scenarios, when the container display area is in an unfolded state (i.e., the display state of the area 202 in FIG. 2), since the space in the container display area is limited, in order to better improve the information display effect, the present disclosure further provides a possible implementation of the information processing method, in which the information processing method includes at least step 34 below. The execution time of step 34 is later than that of the above step 33.

Step 34: Switch, in response to an information switch operation triggered for the container display area, the information-bearing container being displayed within the container display area.

The information switch operation may be set in advance according to an application scenario. For example, the information switch operation may be a trigger operation for a switch control. For another example, the information switch operation may be a scroll operation triggered for the container display area.

Based on the relevant content of the above step 34, it can be seen that for a communication system (e.g., a certain type of instant messaging software), when a container display area is being displayed in a chat interface of a client of the communication system and the container display area is in an unfolded state (i.e., the display state of the area 202 in FIG. 2), the information-bearing container being displayed within the container display area may be switched based on user operations, so that the user can view more information that requires attention in the container display area, which is conducive to improving the user experience.

In practice, in some application scenarios, since the container display area in the unfolded state occupies a large space, in order to better satisfy display space requirements of other information, the present disclosure further provides a possible implementation of the above information processing method, in which the information processing method includes at least any one of steps 35 to 37 below. The execution times of step 35, step 36, and step 37 are all later than that of the above step 31 (or all later than that of the above step 33, or all later than that of the above step 32).

Step 35: Reduce the display area of the container display area in response to a second swipe operation triggered for the container display area. A movement direction of the second swipe operation is opposite to that of the first swipe operation.

The second swipe operation is used to trigger a reduction process for the display area of the container display area. Moreover, the second swipe operation is not limited in the present disclosure. For example, the second swipe operation may be a push-up operation shown in FIG. 2 (i.e., an operation to press and hold a certain position in the container display area and swipe in a direction toward the top boundary line of the chat interface).

In practice, in order to better improve the information display effect, the present disclosure further provides a possible implementation of the above step 35, in which when the chat interface includes a container display area and a chat display area, step 35 may specifically be: in response to the second swipe operation triggered for the container display area, reducing the display area of the container display area, and increasing the display area of the chat display area, so that an increase amount in the display area of the chat display area is equal to a reduction amount in the display area of the container display area.

Step 36: Reduce the display area of the container display area in response to a swipe operation triggered for the chat display area in the chat interface. The chat display area is used to display chat messages in a chat corresponding to the chat interface.

It should be noted that the “swipe operation” in step 36 may be set in advance according to an application scenario. For example, the swipe operation may refer to a swipe operation to move along the vertical direction that is triggered in the chat display area.

It should be further noted that the implementation of the step “reducing the display area of the container display area” in step 36 is similar to the implementation of the step “reducing the display area of the container display area”in the above step 35, which will not be repeated here for the sake of brevity.

Step 37: Reduce the display area of the container display area in response to a trigger operation for an information input control in the chat interface.

It should be noted that reference may be made to the above description for the relevant content of the “information input control” in step 37. Moreover, the “trigger operation” in step 37 may be set in advance according to an application scenario. For example, the trigger operation may refer to a tap operation triggered for the information input control. For another example, when the information input control includes a text input box, the “trigger operation”may refer to an operation to wake up a keyboard.

It should be further noted that the implementation of the step “reducing the display area of the container display area” in step 37 is similar to the implementation of the step “reducing the display area of the container display area”in the above step 35, which will not be repeated here for the sake of brevity.

Based on the relevant content of the above steps 35 to 37, it can be seen that for a communication system (e.g., a certain type of instant messaging software), when a container display area is being displayed in a chat interface of a client of the communication system and the container display area is in a non-folded state (e.g., the display state shown in the area 202 in FIG. 2, or the default state shown in the area 201 in FIG. 2), after some operations triggered for the chat interface (e.g., a push-up operation triggered for the container display area, a swipe-up or swipe-down operation triggered for a chat area in the chat interface, or a trigger operation for an information input control in the chat interface, etc.) are received, the display area of the container display area may be reduced, and the display area of the chat display area may be increased. In this way, the boundary line between the container display area and the chat display area can be dynamically adjusted, so as to better improve the information display effect, which is conducive to improving the user experience.

In practice, in order to better improve the information display effect, when the container display area is in an unfolded state (e.g., the display state of the area 202 in FIG. 2), the container display area may be folded in a multi-stage manner. Based on this, the present disclosure further provides a folding process for the container display area, which may specifically include steps 41 to 42 below.

Step 41: Upon determining that the display area of the container display area is reduced to a first area threshold, cancel display of some or all of the information-bearing containers displayed within the newly added space. The first area threshold may be set in advance according to an application scenario.

In the present disclosure, for a communication system (e.g., a certain type of instant messaging software), when a container display area is being displayed in a chat interface of a client of the communication system and the container display area is in an unfolded state (i.e., the display state of the area 202 in FIG. 2), after some operations triggered for the chat interface (e.g., a push-up operation triggered for the container display area, etc.) are received, the display area of the container display area may be reduced, and display of some or all of the information-bearing containers displayed within the newly added space may be gradually canceled as the display area of the container display area decreases. In this way, the display state of the container display area can be adjusted from the state of the area 202 in FIG. 2 to the state of the area 204 in FIG. 2, so as to better improve the information display effect.

Step 42: Upon determining that the display area of the container display area is reduced to a second area threshold, cancel display of the container that meets the preset condition within the container display area, or cancel display of the container display area on the chat interface. The second area threshold may be set in advance according to an application scenario, and the second area threshold is less than the first area threshold.

In the present disclosure, for a communication system (e.g., a certain type of instant messaging software), when a container display area is being displayed in a chat interface of a client of the communication system and the container display area is in an unfolded state (i.e., the display state of the area 202 in FIG. 2), after some operations triggered for the chat interface (e.g., a push-up operation triggered for the container display area, etc.) are received, the display area of the container display area may be reduced, until only one information-bearing container is displayed within the container display area. In this way, when it is determined that the user is still performing the operation, display of the information-bearing container may be canceled directly within the container display area (e.g., the state shown in the area 205 in FIG. 2), or display of the container display area may be canceled directly on the chat interface (e.g., the state shown in the chat interface 206 in FIG. 4).

Based on the relevant content of the above steps 41 to 42, it can be seen that for a container display area in an unfolded state (e.g., the area 202 in FIG. 2), the container display area can be folded by means of two display area reduction stages, to achieve a folding process for the container display area, so as to better satisfy the information display requirements.

In practice, for the container display area being displayed, the container display area may be hidden during the user's viewing of the chat information, to ensure the display effect of the chat information. Based on this, the present disclosure further provides a possible implementation of the above information processing method, in which the information processing method may include at least step 51 below. The execution time of step 51 is later than that of the above step “displaying the container display area in the chat interface of the client of the communication system”.

Step 51: In response to a swipe operation triggered for a chat display area in a chat interface, cancel display of the container display area on the chat interface, and increase the display area of the chat display area in the chat interface, so that an increase amount in the display area of the chat display area is equal to the display area of the container display area.

It can be seen that for a communication system (e.g., a certain type of instant messaging software), when a container display area is being displayed in a chat interface of a client of the communication system, after the client of the communication system detects a swipe operation triggered for a chat display area in the chat interface, the container display area may be directly hidden, and the display area of the chat display area in the chat interface may be increased, so that an increase amount in the display area of the chat display area is equal to the display area of the container display area. In this way, the chat interface can provide a sufficient space for displaying chat information, which is conducive to improving the display effect of the chat information.

In practice, in some application scenarios (e.g., when the information method provided in the present disclosure is applied to a large-screen terminal like a computer), in order to better improve the information display effect, the present disclosure further provides a possible implementation of the above information processing method, in which when the container display area is located within a sidebar area of the chat interface and the chat interface includes a container entry identifier (e.g., the label “Group component” shown in the area 302 in FIG. 3), the information processing method may include at least step 61 below.

Step 61: After the container display area is displayed in the chat interface of the client of the communication system, cancel display of the container display area on the chat interface in response to a trigger operation for the container entry identifier.

Reference may be made to the above description for the relevant content of the container entry identifier.

In addition, the deployment position of the container entry identifier in the chat interface is not limited in the present disclosure. For example, when the chat interface includes a title area, the container entry identifier may be within the title area. The title area is used to display title information of the chat interface and an entry identifier of some data information.

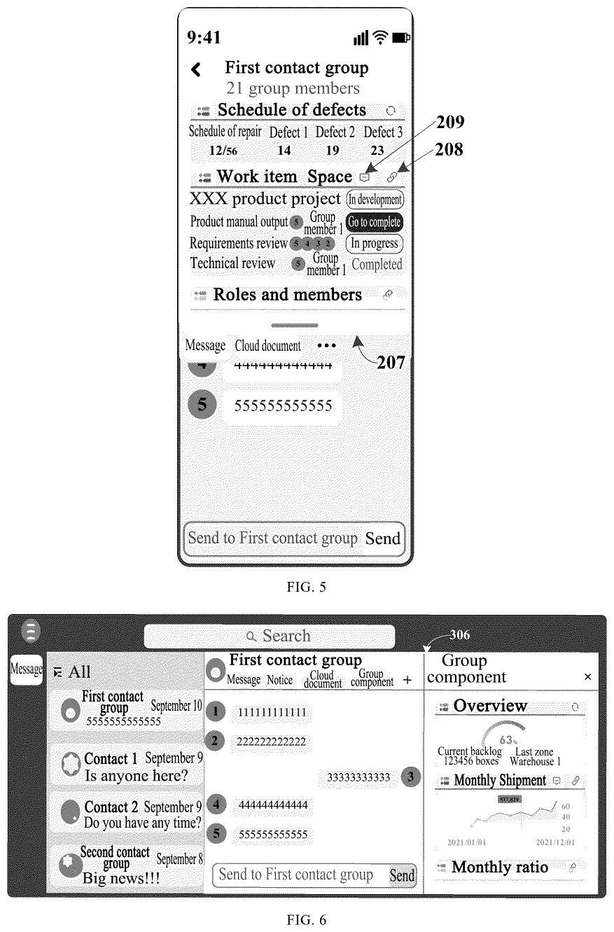

Based on the relevant content of the above step 61, it can be seen that for a communication system applied to a computer (e.g., a certain type of instant messaging software), when a container display area is being displayed in a chat interface of a client of the communication system and a container entry identifier is displayed in the chat interface (e.g., the label “Group component” shown in the area 302 in FIG. 3, or the label “Group component” shown in the area 306 in FIG. 6), the user may open or close the container display area by means of a tap operation for the container entry identifier.

In practice, for the container display area, it is usually possible to configure the container display area to be displayed with the opening of the chat interface. However, if the user adjusts the display state of the container display area on the chat interface before leaving the chat interface, for example, closing the container display area (e.g., the state shown in the interface 205 in FIG. 3), folding the container display area (e.g., the state shown in the area 205 in FIG. 2), or unfolding the container display area (e.g., the state shown in the area 202 in FIG. 2), etc., when the user re-enters the chat interface, the container display area remains in the display state before the user left the chat interface, which is conducive to improving the user experience.

In practice, in some application scenarios, in order to better improve the user experience, the present disclosure further provides a possible implementation of the information-bearing container, in which the information-bearing container may include one or more controls (e.g., a link copy control 208 and a comment control 209 shown in FIG. 5), so that the user can better view/use/comment on the content borne and displayed by the information-bearing container by means of the controls. For ease of understanding, description is made below in conjunction with two examples.

Example 1: in a possible implementation, when the information-bearing container includes at least a first control (e.g., the link copy control 208 shown in FIG. 5), the information processing method provided in the present disclosure may include at least step 71 below.

Step 71: Copy a link address of the preset information in response to a trigger operation for the first control in the information-bearing container. A page corresponding to the link address is used to display the preset information.

The first control refers to a control deployed in the information-bearing container for copying a link address corresponding to the content borne and displayed by the information-bearing container. For example, the first control may be the link copy control 208 shown in FIG. 5.

The “link address of the preset information” is used to uniquely identify a web page corresponding to the preset information. Moreover, the “web page corresponding to the preset information” is used to display the preset information.

The “page corresponding to the link address” refers to a web page that can be accessed based on the link address (i.e., the “web page corresponding to the preset information”).

Based on the relevant content of the above step 71, it can be seen that for a communication system (e.g., a certain type of instant messaging software), when an information-bearing container is being displayed in a chat interface of a client of the communication system, preset information is displayed in the information-bearing container, and a first control is deployed in the information-bearing container, upon receiving a trigger operation (e.g., a tap operation, etc.) for the first control, a link address of the preset information is copied, so that the user can then directly view a web page corresponding to the preset information by using the link address, or after the user shares the link address with other users, the other users can directly view the web page corresponding to the preset information by using the link address.

Example 2: in a possible implementation, when the information-bearing container includes at least a second control (e.g., the link copy control 209 shown in FIG. 5), the information processing method provided in the present disclosure may include at least step 81 below.

Step 81: Display a comment input control in response to a trigger operation for the second control in the information-bearing container.

The second control refers to a control deployed in the information-bearing container for performing comment input processing on the content borne and displayed by the information-bearing container. For example, the second control may be the comment control 209 shown in FIG. 5.

The comment input control is used to provide a comment input function. Moreover, the implementation of the comment input control is not limited in the present disclosure.

In practice, in order to better improve the user experience, an embodiment of the present disclosure further provides a possible implementation of the above step 81, which may specifically be: in response to the trigger operation for the second control in the information-bearing container, jumping to the page corresponding to the preset information, and displaying the comment input control in the page corresponding to the preset information. Reference may be made to the above description for the relevant content of the “page corresponding to the preset information”.

In addition, for the “page corresponding to the preset information”, the “page corresponding to the preset information” may be deployed with some comment input controls, to enable the user to comment on the preset information by means of the comment input controls. The comment input control refers to a control to be used during inputting of comment content. Moreover, the implementation of the comment input control is not limited in the present disclosure.

Based on the relevant content of the above step 81, it can be seen that for a communication system (e.g., a certain type of instant messaging software), when an information-bearing container is being displayed in a chat interface of a client of the communication system, preset information is displayed in the information-bearing container, and a second control is deployed in the information-bearing container, upon receiving a trigger operation (e.g., a tap operation, etc.) for the second control, the page jumps from the chat interface to a page corresponding to the preset information, and a comment input control is displayed in the page corresponding to the preset information, so that the user can then input comment content for the preset information by means of the comment input control.

It should be noted that for FIGS. 5 and 6 above, the two drawings are merely reference examples for displaying the content borne and displayed by the information-bearing container, and the implementation of the content borne and displayed by the information-bearing container is not limited in the present disclosure.

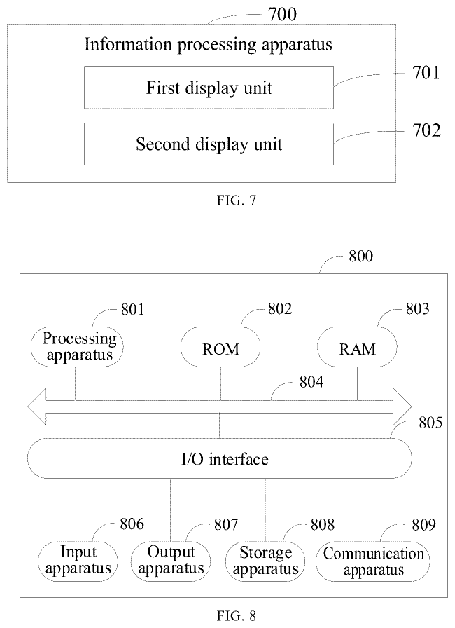

Based on the information processing method according to the embodiments of the present disclosure, an embodiment of the present disclosure further provides an information processing apparatus, which is explained and described below with reference to FIG. 7. FIG. 7 is a schematic diagram of a structure of an information processing apparatus according to an embodiment of the present disclosure. It should be noted that for the technical details of the information processing apparatus provided in the embodiment of the present disclosure, refer to the relevant content of the information processing method described above.

As shown in FIG. 7, the information processing apparatus 700 provided in the embodiment of the present disclosure includes:

a first display unit 701 configured to display one or more information-bearing containers in a chat interface of a client of a communication system in response to a first preset operation; and
a second display unit 702 configured to display preset information in the one or more information-bearing containers, where the preset information is not a chat message in a chat corresponding to the chat interface.

In a possible implementation, the first display unit 701 includes:

a first display sub-unit configured to display a container display area in the chat interface of the client of the communication system; and
a second display sub-unit configured to display the one or more information-bearing containers in the container display area.

In a possible implementation, the second display unit 702 is specifically configured to: obtain, for one information-bearing container, data from a business party associated with the information-bearing container, and display the obtained data in the information-bearing container, where when the chat interface includes a plurality of information-bearing containers, the plurality of information-bearing containers correspond to the same business party or different business parties.

In a possible implementation, the second display unit 702 is specifically configured to: render and display the obtained data in the information-bearing container based on a display template provided by the business party.

In a possible implementation, there is a preset association between the information-bearing container and a preset link address of the business party, and the second display unit 702 is specifically configured to: obtain the data of the business party from a page corresponding to the preset link address associated with the information-bearing container.

In a possible implementation, there is a preset association between the information-bearing container and a preset information access interface of the business party, and

the second display unit 702 is specifically configured to: obtain the data of the business party from the preset information access interface associated with the information-bearing container.

In a possible implementation, the information processing apparatus 700 further includes:

an information update unit configured to update, in real time and based on changes in the preset information, information displayed in the one or more information-bearing containers.

In a possible implementation, the first preset operation includes any one of the following:

an operation to open the chat interface; and
a second preset operation triggered in the chat interface.

In a possible implementation, the information processing apparatus 700 further includes:

a state adjustment unit configured to: after the container display area is displayed in the chat interface of the client of the communication system, adjust the container display area from a first display state to a second display state in response to a preset adjustment operation, where a display area of the container display area in the first display state is different from that of the container display area in the second display state.

In a possible implementation, when the chat interface includes a plurality of information-bearing containers, the second display sub-unit is specifically configured to: display, within the container display area, a container among the plurality of information-bearing containers that meets a preset condition; and

the information processing apparatus 700 further includes:
an area unfolding unit configured to: after the container among the plurality of information-bearing containers that meets a preset condition is displayed within the container display area, in response to a first swipe operation triggered for the container display area, increase a display area of the container display area, and display, within a newly added space of the container display area, at least one information-bearing container among the plurality of information-bearing containers other than the container that meets the preset condition.

In a possible implementation, the information processing apparatus 700 further includes:

a first folding unit configured to: after the display area of the container display area is increased, reduce the display area of the container display area in response to a second swipe operation triggered for the container display area, where a movement direction of the second swipe operation is opposite to that of the first swipe operation;
or
a second folding unit configured to: after the display area of the container display area is increased, reduce the display area of the container display area in response to a swipe operation triggered for a chat display area in the chat interface, where the chat display area is used to display chat messages in the chat corresponding to the
or
a third folding unit configured to: after the display area of the container display area is increased, reduce the display area of the container display area in response to a trigger operation for an information input control in the chat interface.

In a possible implementation, the information processing apparatus 700 further includes:

a first hiding unit configured to: after the display area of the container display area is reduced, upon determining that the display area of the container display area is reduced to a first area threshold, cancel display of some or all of the information-bearing containers displayed within the newly added space; and
a second hiding unit configured to: upon determining that the display area of the container display area is reduced to a second area threshold, cancel display of the container that meets the preset condition within the container display area, or cancel display of the container display area on the chat interface, where the second area threshold is less than the first area threshold.

In a possible implementation, the container display area is located within a sidebar area of the chat interface; the chat interface includes a container entry identifier; and

the information processing apparatus 700 further includes:
a third hiding unit configured to: after the container display area is displayed in the chat interface of the client of the communication system, cancel display of the container display area on the chat interface in response to a trigger operation for the container entry identifier.

In a possible implementation, the information processing apparatus 700 further includes:

an address copy unit configured to copy a link address of the preset information in response to a trigger operation for a first control in the information-bearing container, where a page corresponding to the link address is used to display the preset information;
or
a control display unit configured to display a comment input control in response to a trigger operation for a second control in the information-bearing container.

In a possible implementation, the information-bearing container is a widget.

Based on the relevant content of the information processing apparatus 700, it can be seen that for the information processing apparatus 700 provided in this embodiment of the present disclosure, upon receiving a first preset operation (e.g., an operation to open a chat interface of a certain group, etc.), one or more information-bearing containers are displayed in the chat interface of the client of the communication system, and preset information (e.g., information that requires attention from some or all members of a certain chat group) is displayed in these information-bearing containers, so that the preset information is not displayed as a chat message in a chat corresponding to the chat interface, but displayed in a display manner that is completely different from that of chat information. In this way, all chat messages involved in the chat interface do not interfere with the user's process of paying attention to the preset information, so as to better improve the display effect of some information in the chat interface (especially the display effect of some information that requires attention), which is conducive to improving the user experience (especially the viewing experience for some information that requires attention).

In addition, an embodiment of the present disclosure further provides an electronic device. The device includes a processor and a memory, where the memory is configured to store instructions or a computer program; and the processor is configured to execute the instructions or computer program in the memory, to cause the electronic device to perform any implementation of the information processing method according to the embodiments of the present disclosure.

Reference is made to FIG. 8, which is a schematic diagram of a structure of an electronic device 800 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 8 is merely an example, and shall not impose any limitation on the function and scope of use of the embodiments of the present disclosure.

As shown in FIG. 8, the electronic device 800 may include a processing apparatus (e.g., a central processing unit or a graphics processing unit) 801 that may perform a variety of appropriate actions and processing in accordance with a program stored in a read-only memory (ROM) 802 or a program loaded from a storage apparatus 808 into a random access memory (RAM) 803. The RAM 803 further stores various programs and data required for operations of the electronic device 800. The processing apparatus 801, the ROM 802, and the RAM 803 are connected to one another through a bus 804. An input/output (I/O) interface 805 is also connected to the bus 804.

Generally, the following apparatuses may be connected to the I/O interface 805: an input apparatus 808 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 809, installed from the storage apparatus 808, or installed from the ROM 802. When the computer program is executed by the processing apparatus 801, the above-mentioned functions defined in the method of the embodiment of the present disclosure are performed.

The electronic device according to this embodiment of the present disclosure and the method according to the above embodiments belong to the same inventive concept. For the technical details not exhaustively described in this embodiment, reference may be made to the above embodiments, and this embodiment and the above embodiments have the same beneficial effects.

An embodiment of the present disclosure further provides a computer-readable medium storing instructions or a computer program that, when run on a device, cause the device to perform any implementation of the information processing method according to the embodiments of the present disclosure.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The computer-readable medium may be contained in the electronic device. Alternatively, the computer-readable medium may exist independently, without being assembled into the electronic device.

The computer-readable medium carries one or more programs that, when executed by the electronic device, enable the electronic device to perform the above method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments shown herein, but extends to the widest scope that complies with the principles and novelty disclosed in this specification.

1. An information processing method, comprising:
displaying one or more information-bearing containers in a chat interface of a client of a communication system in response to a first preset operation; and
displaying preset information in the one or more information-bearing containers,
wherein the preset information is not a chat message in a chat corresponding to the chat interface.

2. The method according to claim 1, wherein displaying the one or more information-bearing containers in the chat interface of the client of the communication system comprises:
displaying a container display area in the chat interface of the client of the communication system, and displaying the one or more information-bearing containers in the container display area.

3. The method according to claim 1, wherein displaying the preset information in the one or more information-bearing containers comprises:
obtaining, for one information-bearing container, data from a business party associated with the information-bearing container, and displaying the obtained data in the information-bearing container,
wherein in a case where the chat interface comprises a plurality of information-bearing containers, the plurality of information-bearing containers correspond to the same business party or different business parties.

4. The method according to claim 3, wherein displaying the obtained data in the information-bearing container comprises:
rendering and displaying the obtained data in the information-bearing container based on a display template provided by the business party.

5. The method according to claim 3, wherein
there is a preset association between the information-bearing container and a preset link address of the business party, and
obtaining the data from the business party associated with the information-bearing container comprises: obtaining the data of the business party from a page corresponding to the preset link address associated with the information-bearing container;
or
there is a preset association between the information-bearing container and a preset information access interface of the business party, and
obtaining the data from the business party associated with the information-bearing container comprises: obtaining the data of the business party from the preset information access interface associated with the information-bearing container.

6. The method according to claim 1, further comprising:
updating, in real time and based on changes in the preset information, information displayed in the one or more information-bearing containers.

7. The method according to claim 1, wherein the first preset operation comprises any one of:
an operation to open the chat interface; or
a second preset operation triggered in the chat interface.

8. The method according to claim 2, wherein after displaying the container display area in the chat interface of the client of the communication system, the method further comprises:
adjusting the container display area from a first display state to a second display state in response to a preset adjustment operation, wherein a display area of the container display area in the first display state is different from a display area of the container display area in the second display state.

9. The method according to claim 2, wherein in a case where the chat interface comprises the plurality of information-bearing containers, displaying the one or more information-bearing containers in the container display area comprises:
displaying, within the container display area, a container among the plurality of information-bearing containers that meets a preset condition; and
wherein after displaying, within the container display area, the container among the plurality of information-bearing containers that meets the preset condition, the method further comprises:
in response to a first swipe operation triggered for the container display area, increasing a display area of the container display area, and displaying, within a newly added space of the container display area, at least one information-bearing container among the plurality of information-bearing containers other than the container that meets the preset condition.

10. The method according to claim 9, wherein after increasing the display area of the container display area, the method further comprises:
reducing the display area of the container display area in response to a second swipe operation triggered for the container display area, wherein a movement direction of the second swipe operation is opposite to a movement direction of the first swipe operation;
or
reducing the display area of the container display area in response to a swipe operation triggered for a chat display area in the chat interface, wherein the chat display area is used to display chat messages in the chat corresponding to the chat interface;
or
reducing the display area of the container display area in response to a trigger operation for an information input control in the chat interface.

11. The method according to claim 10, wherein after reducing the display area of the container display area, the method further comprises:
upon determining that the display area of the container display area is reduced to a first area threshold, canceling display of some or all of the information-bearing containers displayed within the newly added space; and
upon determining that the display area of the container display area is reduced to a second area threshold, canceling display of the container that meets the preset condition within the container display area, or canceling display of the container display area on the chat interface, wherein the second area threshold is less than the first area threshold.

12. The method according to claim 2, wherein the container display area is located within a sidebar area of the chat interface;
wherein the chat interface comprises a container entry identifier; and
wherein after displaying the container display area in the chat interface of the client of the communication system, the method further comprises:
canceling display of the container display area on the chat interface in response to a trigger operation for the container entry identifier.

13. The method according to claim 1, further comprising:
copying a link address of the preset information in response to a trigger operation for a first control in the information-bearing container, wherein a page corresponding to the link address is used to display the preset information;
or
displaying a comment input control in response to a trigger operation for a second control in the information-bearing container.

14. The method according to claim 1, wherein the information-bearing container is a widget.

15. (canceled)

16. An electronic device, comprising a processor and a memory, wherein
the memory is configured to store instructions or a computer program; and
the processor is configured to execute the instructions or computer program in the memory to cause the electronic device to:
display one or more information-bearing containers in a chat interface of a client of a communication system in response to a first preset operation; and
display preset information in the one or more information-bearing containers,
wherein the preset information is not a chat message in a chat corresponding to the chat interface.

17. A non-transitory computer-readable medium storing instructions or a computer program, wherein when the instructions or the computer program runs on a device, the device is caused to:
display one or more information-bearing containers in a chat interface of a client of a communication system in response to a first preset operation; and
display preset information in the one or more information-bearing containers,
wherein the preset information is not a chat message in a chat corresponding to the chat interface.

18. The electronic device according to claim 16, wherein the electronic device is caused to display the one or more information-bearing containers in the chat interface of the client of the communication system by being caused to:
display a container display area in the chat interface of the client of the communication system, and display the one or more information-bearing containers in the container display area.

19. The electronic device according to claim 16, wherein the electronic device is caused to display the preset information in the one or more information-bearing containers by being caused to:
obtain, for one information-bearing container, data from a business party associated with the information-bearing container, and display the obtained data in the information-bearing container,
wherein in a case where the chat interface comprises a plurality of information-bearing containers, the plurality of information-bearing containers correspond to the same business party or different business parties.

20. The electronic device according to claim 19, wherein the electronic device is caused to display the obtained data in the information-bearing container by being caused to:
render and display the obtained data in the information-bearing container based on a display template provided by the business party.

21. The electronic device according to claim 19, wherein
there is a preset association between the information-bearing container and a preset link address of the business party, and
the electronic device is caused to obtain the data from the business party associated with the information-bearing container by being caused to: obtain the data of the business party from a page corresponding to the preset link address associated with the information-bearing container;
or
there is a preset association between the information-bearing container and a preset information access interface of the business party, and
the electronic device is caused to obtain the data from the business party associated with the information-bearing container by being caused to: obtain the data of the business party from the preset information access interface associated with the information-bearing container.
